(19) United States
(12) Patent Application Publication
(10) Pub. No.: US 2026/0232138 A1
(43) Pub. Date: Aug. 13, 2026

(54) MACHINE AND METHOD FOR PREPARING COFFEE AND METHOD AND APPARATUS FOR CALIBRATING A COFFEE GRINDER

(71) Applicant: ILLYCAFFE' S.P.A., Trieste (IT)

(72) Inventors: Christian BRACICH, Trieste (TS) (IT); Marco FERRARI, Muggia (TS) (IT); Francesco CESCUTTI, Trieste (TS) (IT); Riccardo PIRAS, Trieste (TS) (IT)

(21) Appl. No.: 19/154,637

(22) PCT Filed: Feb. 7, 2024
(86) PCT No.: PCT/IT2024/050031

§ 371 Date: Aug. 7, 2025

(30) Foreign Application Priority Data
Feb. 7, 2023 (IT) 102023000002028

(51) Int. Cl. A47J 42/08; A47J 31/36; A47J 31/42; A47J 31/46; A47J 42/18; G06N 3/09

(52) U.S. Cl. CPC A47J 42/08; A47J 31/3671; A47J 31/42; A47J 31/468; A47J 42/18; G06N 3/09

(57) ABSTRACT

A method for calibrating a coffee grinder includes receiving input of sets of extraction data of one or more coffee extraction process parameters, processing the extraction data using an algorithm that implements an artificial intelligence model based on machine-learning, and generating an output data set which includes information used to calibrate a coffee grinder.

### FIELD OF THE INVENTION

The present invention concerns a machine and method for preparing coffee and a method and apparatus for calibrating a coffee grinder using an artificial intelligence (AI) algorithm, in particular based on machine-learning. The present invention can be used to give an indication for calibrating, perfecting or adjusting a coffee grinder, or a grinder-dispenser, able to grind coffee beans for the preparation of a coffee beverage of any type whatsoever, for example espresso coffee, long coffee, American coffee or similar or comparable coffee-based beverages.

### BACKGROUND OF THE INVENTION

In the world of coffee machines, the grinding degree of the coffee powder plays a fundamental role. In order to achieve a perfect delivery, it is essential that the grinding degree is kept within certain limits, in terms of granulometry.

In a coffee shop scenario, it is not possible to directly observe the coffee powder's granulometry, since this is a laboratory task. Instead, the bartender would use their experience to determine whether the grinding is optimal, for example, by preparing an espresso coffee and measuring the delivery time; then, depending on the measurement, the bartender would calibrate the grinder or grinder-dispenser. This involves, in practice, manually adjusting the distance between the grinders, by tightening or loosening them, that is, moving them closer or further apart accordingly, in order to produce a finer or coarser powder, respectively. Another operational parameter of the coffee grinder which the bartender could manually intervene on, in combination with the aforementioned distance adjustment, is the activation time of the grinders, which naturally influences the amount of coffee that is ground.

In reality, this manual approach works because the hydraulic resistance of the coffee brick in the extraction chamber depends, in addition to the amount of coffee and its pressing, also on the grinding degree of the coffee powder: the finer the coffee powder, the higher the hydraulic resistance and therefore the longer the extraction time.

This manual calibration method presents some problems, such as variability during the pressing of the coffee in the filter holder, the need for the barista's physical presence, for example when measuring the extraction time, the need for the barista's competence in understanding the result, the need to remove the grinder when a drift is observed.

The document Mesin, L. et al. doi: 10.1109/IJCNN.2012.6252493 concerns, in general, continuous controls in the food industry and product quality assessments, as required by European standards. This document describes the use of a neural network to control two industrial grinders used for the production of ground coffee at a factory. According to this document, the quality of food products in each production plant has to be maintained at a high level along the entire production chain. Various external factors can influence the quality of the final product, such as material, mashing, fermentation, maturation and mixing conditions. For this reason, automated controls are necessary to ensure high and stable production quality. In addition, adaptive control is often needed, since different food varieties can require similar treatments. An example of an adaptive system applied to the food industry described in this document is represented by Artificial Neural Networks (ANN). This document presents the analyses carried out on different features of interest related to the production of coffee in an industrial plant. The purpose is to study time series of coffee features and their degree of reciprocal influence using ANN. In this way, the behavior of the main variables can be controlled and predicted during the production of ground coffee in order to help and give the utmost to human operators with the safest and most likely regulatory estimates. In this document, therefore, the purpose is to prevent an unwanted interruption of the entire production chain that can occur if some of the most important parameters go outside a desired range. This document records the data sets of some coffee production variables along the production line. Granulometry and densitometry are performed on coffee particles obtained after grinding, in order to verify the quality of the product. The resulting data sets consist of time series sampled in variable time instants. The product features are described by the variables extracted from the granulometry and density, based on these variables, the operator decides how to control the grinders. To support the operator's decision, a neural control system was considered: two supervised artificial neural networks (ANN) were used to command the first and second grinder, respectively, therefore the output was the distance between the wheels of the first and second grinder, respectively. The possible input variables were the granulometry and density data mentioned above, measured at the present time or with a delay of up to two sampling intervals and the output delayed by up to two sampling intervals. According to this document, the selection of the optimal input features for the ANN is of great importance, in order to reduce measurement noise, counteract the difficulties of dealing with a large problem and improve performance.

Document WO 2022/207953 A1 describes a monitoring method for coffee grinders, of the type comprising a main hopper or inlet cartridge, a plurality of grinders and one or more intermediate hoppers for the ground coffee. The method comprises: measuring the time of use of the grinders, for each use and in total, measuring the temperature and ambient moisture, measuring the height reached by the ground coffee accumulated in the intermediate hoppers, calculating the estimated height that the coffee will have to reach in the intermediate hoppers, based on the parameters specified above, and comparing it with the actual height reached, providing a value for modifying the activation time of the grinders for each use, as well as for adjusting the separation or force between the grinders so that the weight of the dose served is as close as possible to the programmed weight of the dose. For a given status of the grinders and a given granularity setting, a mathematical relationship is established, for example through machine learning, between the time spent grinding and the grams of coffee obtained. The relationship between the data obtained from the time of use of the motor and the volume data in the intermediate hopper offers information regarding, among others, the useful life of the grinders, the granularity value of the grinding and the quality of the resulting service. Through a suitable calibration and training of the algorithm present in the control unit, from the monitored variables (time, volume, moisture and temperature) one obtains the desired information (weight, granularity and status of the grinders).

Document U.S. Pat. No. 5,645,230 A describes a device for controlling the grinding of coffee comprising a pair of facing grinding plates whose distance is adjustable so as to be able to vary the sizes of the coffee beans obtainable during grinding. The distance between the grinding plates is adjustable as a function of the moisture value detected by an ambient moisture sensor.

There is therefore the need to perfect a machine for preparing coffee, a method for preparing coffee, a method and an apparatus for calibrating a coffee grinder, that can overcome at least one of the disadvantages of the state of the art.

In particular, one purpose of the present invention is to provide a machine for preparing coffee, a method for preparing coffee, a method, and a connected apparatus, for calibrating a coffee grinder that are repeatable, standardizable and controlled, and that possibly can also be automated.

Even more in particular, it is a purpose of the present invention to make operational steps of the method for preparing coffee and adjusting the coffee grinder automatic and/or repeatable, in order to supply, as output, information that, directly or indirectly, is used, manually or automatically, to calibrate the coffee grinder.

Another purpose of the present invention is to provide a machine for preparing coffee, a method for preparing coffee, a method, and a connected apparatus, for calibrating a coffee grinder, which integrate within them the competence and professional knowledge that a bartender, who normally carries out the manual adjustment of the coffee grinder, would have.

### SUMMARY OF THE INVENTION

The present invention is set forth and characterized in the independent claims, while the dependent claims describe other characteristics of the present invention or variants to the main inventive idea.

In accordance with the above purposes, some embodiments described here concern a machine for preparing coffee having a coffee extraction chamber able to contain a certain quantity of powdered coffee obtained by grinding coffee beans in at least one coffee grinder, the machine comprising a control unit configured to receive an input of sets of extraction data of one or more process parameters for the extraction of coffee in the machine, the one or more process parameters being acquired over time during at least one coffee extraction operation carried out in the extraction chamber where the quantity of powdered coffee is present.

According to one embodiment, the control unit can be associated with at least one processor to process the extraction data using an algorithm which implements an artificial intelligence model based on machine-learning.

This algorithm generates an output data set that includes information used to calibrate the coffee grinder at least by adjusting a distance between the grinders of the at least one coffee grinder.

According to some embodiments, the at least one processor as above can be associated locally or remotely (for example, “cloud computing”) with the control unit.

According to one embodiment, the one or more process parameters include one or more of either: pressure measured in the extraction chamber, flow of water fed into the extraction chamber and/or temperature of the water fed into the extraction chamber.

According to other embodiments, there is provided a method for preparing coffee in a coffee preparation machine having a coffee extraction chamber able to contain a certain quantity of powdered coffee obtained by grinding coffee beans in at least one coffee grinder.

According to one embodiment, the method comprises receiving an input of sets of extraction data of one or more process parameters for the extraction of coffee in the machine in a control unit of the machine, the one or more process parameters being acquired over time during at least one coffee extraction operation carried out in the extraction chamber where the quantity of powdered coffee is present,
processing the extraction data by means of at least one processor associated with the control unit using an algorithm that implements an artificial intelligence model based on machine-learning,
the algorithm generating an output data set that includes information used to calibrate the coffee grinder at least by adjusting a distance between the grinders of the at least one coffee grinder,
wherein the one or more process parameters include one or more of either: pressure measured in the extraction chamber, flow of water fed into the extraction chamber and/or temperature of the water fed into the extraction chamber.

In accordance with one embodiment, which can be combined with all embodiments described here, all three of the process parameters indicated above are used, in particular a choice of two of the process parameters are detected and kept fixed at a desired setpoint value, while the third is left free to vary and detected.

In accordance with other embodiments, a computer-implemented method for calibrating a coffee grinder is provided, comprising:
receiving an input of sets of extraction data of one or more coffee extraction process parameters generated by a coffee preparation machine, for example including pressure, flow and/or temperature, and acquired over time during at least one coffee extraction operation carried out in the extraction chamber, in which there is a quantity of powdered coffee obtained by grinding coffee beans in a coffee grinder;
processing the extraction data using an algorithm that implements an artificial intelligence (AI) model based on machine-learning;
generating an output data set that includes information used to calibrate the coffee grinder at least by adjusting a distance between the grinders of the coffee grinder.

Other embodiments described here concern an apparatus for calibrating a coffee grinder, comprising:
a control unit configured to receive an input of sets of extraction data of one or more process parameters for the extraction of coffee in a coffee preparation machine having a coffee extraction chamber able to contain a certain quantity of powdered coffee obtained by grinding coffee beans in a coffee grinder, the one or more process parameters being acquired over time during at least one coffee extraction operation carried out in the extraction chamber where the quantity of powdered coffee is present,
the control unit being associated with at least one processor to process the extraction data using an algorithm that implements an artificial intelligence model based on machine-learning,
the algorithm generating an output data set which includes information used to calibrate the coffee grinder at least by adjusting a distance between the grinders of the coffee grinder.

Other embodiments concern a data processing apparatus comprising means for executing a method in accordance with the embodiments described here.

Other embodiments concern a computer program comprising instructions which, when the program is executed by a computer, cause the computer to implement a method in accordance with the embodiments described here.

Other embodiments concern a computer comprising instructions which, when the program is executed by a computer, cause the computer to implement a method in accordance with the embodiments described here.

The computer can be local, that is, locally associated, for example included in or locally connected to, the coffee preparation machine or in proximity thereto, or a computer available remotely, for example, via “cloud computing” architecture. Such computer can include, for example, the processor described above, which can be local or remote.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a block diagram of how a method according to some embodiments described here can be used;

FIG. 2 is a schematic representation of a part of an apparatus according to some embodiments described here;

FIG. 3 is a schematic representation of an apparatus according to some embodiments described here;

FIG. 4 is a schematic representation of a neural network that can be used in the embodiments described here;

FIG. 5 is a schematic representation of another neural network that can be used in the embodiments described here;

FIG. 6 is a schematic representation of a coffee grinder that can be used in some embodiments described here.

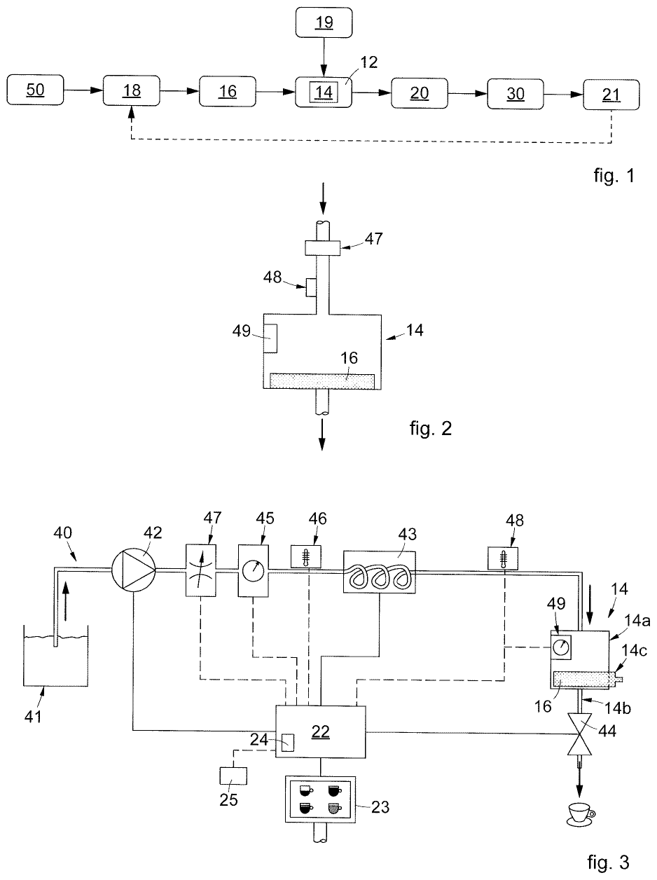

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

Some embodiments described using the attached drawings concern a machine 12 and a method for preparing coffee.

According to some embodiments, the machine 12 has a coffee extraction chamber 14 able to contain a certain quantity of powdered coffee 16 obtained by grinding coffee beans in at least one coffee grinder 18.

The machine 12 comprises a control unit 22 configured to receive an input of sets of extraction data 20 of one or more process parameters for the extraction of coffee in the machine 12.

These one or more process parameters are acquired over time during at least one coffee extraction operation carried out in the extraction chamber 14 where the quantity of powdered coffee 16 is present.

The aforementioned control unit 22 can be associated with at least one processor 24 to process the extraction data 20 using an algorithm which implements an artificial intelligence model 30 based on machine-learning. For example, the at least one processor 24 can be communicatively connected to the control unit 22. For example, the at least one processor 24 can be local, for example included directly in the control unit 22 or locally connected to the control unit 22, or the at least one processor 24 can be remote, that is, connected remotely (for example “cloud computing”), via the internet for example.

The algorithm generates an output data set 21 which includes information used to calibrate the grinder 18 at least by adjusting a distance between the grinders of the at least one coffee grinder 18.

The aforementioned one or more process parameters include one or more of either: pressure measured in the extraction chamber 14, flow of water fed into the extraction chamber 14 and/or temperature of the water fed into the extraction chamber 14.

Other embodiments concern a method for preparing coffee in a machine 12 for preparing coffee having a coffee extraction chamber 14 able to contain a certain quantity of powdered coffee 16 obtained by grinding coffee beans in at least one coffee grinder 18.

The aforementioned method comprises receiving an input of sets of extraction data 20 of one or more process parameters for the extraction of coffee in the machine 12, in a control unit 22 of the machine 12.

These one or more process parameters are acquired over time during at least one coffee extraction operation carried out in the extraction chamber 14 where the quantity of powdered coffee 16 is present.

The method includes processing the extraction data 20 by means of at least one processor 24 associated, locally or remotely, with the control unit 22, using an algorithm which implements an artificial intelligence model 30 based on machine-learning.

The algorithm generates an output data set 21 which includes information used to calibrate the coffee grinder 18 at least by adjusting a distance between the grinders of the at least one coffee grinder 18.

The aforementioned one or more process parameters include one or more of either: pressure measured in the extraction chamber 14, flow of water fed into the extraction chamber 14 and/or temperature of the water fed into the extraction chamber 14.

In accordance with some embodiments, which can be combined with all embodiments described here, all three of the process parameters indicated above can be used, in particular a choice of two of the process parameters are detected and kept fixed at a desired setpoint value, while the third is left free to vary and detected.

Other embodiments concern a computer-implemented method for calibrating a coffee grinder, comprising:
receiving an input of sets of extraction data 20 of one or more process parameters for the extraction of coffee in a machine 12 for preparing coffee, for example including pressure, flow and temperature associated with the extraction process in the extraction chamber 14, and acquired over time during at least one coffee extraction operation carried out in the extraction chamber 14, in which a quantity of powdered coffee 16 obtained by grinding coffee beans in a coffee grinder 18 is present;
processing the extraction data 20 using an algorithm which implements an artificial intelligence (AI) model, or AI model, 30 based on machine-learning;
generating an output data set 21 which includes information used to calibrate the coffee grinder 18 at least by adjusting a distance between the grinders of the coffee grinder 18.

Here and in the present description, when we refer to the coffee prepared by the machine 12, we will always mean liquid coffee, or a coffee-based beverage, typically prepared by means of an extraction process using water and powdered coffee 16. The coffee can be, for example, espresso, long, American, cold or other types.

Furthermore, when we mention the process parameters of pressure, flow and/or temperature, here and in the present description we mean the pressure measured in the extraction chamber 14, the flow of water fed into the extraction chamber 14 and the temperature of the water fed into the extraction chamber 14. According to some embodiments, which can be combined with all embodiments described here, the machine 12 receives an automated sequence of temporally serialized inputs 19 as a consequence of which the extraction of the coffee, that is, the preparation of a certain quantity of coffee, is carried out. The extraction of the coffee in the extraction chamber 14 generates the extraction data 20 which is supplied to the AI model 30.

Some embodiments of the method described here also include grinding the coffee beans into powdered coffee 16 by using the coffee grinder 18, and using this powdered coffee 16 in the machine 12 to perform an extraction operation in order to obtain a coffee-based beverage, following an automated sequence of inputs 19 that generates, as stated, the extraction data 20.

By way of example, according to some embodiments, an apparatus 10 for calibrating a coffee grinder 18, comprises:
a control unit 22 configured to receive an input of sets of extraction data 20 of one or more process parameters for the extraction of coffee in a machine 12 for preparing coffee having a coffee extraction chamber 14 able to contain a certain quantity of powdered coffee 16 obtained by grinding coffee beans in a coffee grinder 18, the one or more process parameters being acquired over time during at least one coffee extraction operation carried out in the extraction chamber 14 where the quantity of powdered coffee 16 is present.

In accordance with some embodiments, which can be combined with all embodiments described here, the control unit 22 is associated, locally or remotely, with at least one processor 24, possibly two or more, to process the extraction data 20 using an algorithm that implements an artificial intelligence (AI) model, or AI model, 30 based on machine-learning. Although in FIG. 3 a processor 24 is shown associated locally, in particular included in the control unit 22, such representation is only a limiting example, in fact the processor 24 could also be connected remotely (for example, “cloud computing”).

In accordance with some embodiments, which can be combined with all embodiments described here, the control unit 22 can be local, that is, associated with the coffee preparation machine or in proximity thereto, or it can be a remotely available control unit 22, via “cloud computing” architecture for example.

The algorithm generates an output data set 21 which includes information used to calibrate the coffee grinder 18 at least by adjusting a distance between the grinders of the coffee grinder 18.

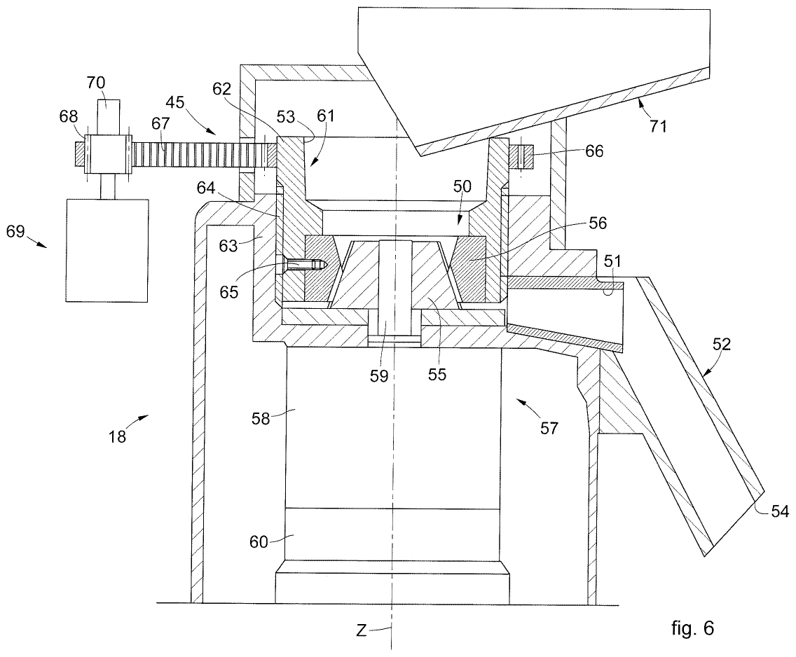

The coffee grinder 18 is used to grind the coffee beans and produce powdered coffee 16 ground with various grinding degrees, as will be described below using FIG. 6.

Some embodiments also concern a data processing apparatus comprising means, for example, but not limited to, the aforementioned control unit 22, for executing a method in accordance with the embodiments described here.

In some embodiments, which can be combined with all embodiments described here, the apparatus 10 can include the machine 12. In other embodiments, the apparatus 10 can include the coffee grinder 18. Moreover, in some embodiments the apparatus 10 can include the machine 12 and the coffee grinder 18.

In some embodiments, the coffee grinder 18 and the machine 12 can be integrated into a single machine for producing coffee. In this case, the coffee grinder 18 is incorporated into the machine 12 and is automatically adjusted according to the output of the AI model 30.

In other embodiments, the coffee grinder 18 can be external to the machine 12.

In some embodiments, both in the case where the coffee grinder 18 and the machine 12 are integrated, and also in the case where the coffee grinder 18 is external to the machine 12, they can be in communication. Communication can be wired or wireless.

In other embodiments, the machine 12 can be connected to a network, such as the Internet, that allows remote monitoring and control of the machine 12 itself. This allows the AI model 30 to be continuously updated and trained on new data, ensuring that the accuracy of the prediction of the appropriate grinding degree remains high.

In another embodiment, the machine 12 can include a user interface 23, such as a touch screen display, that allows the operator to enter various parameters and preferences, such as the type of coffee beans and the desired intensity of the coffee. The AI model 30 processes these inputs and supplies, accordingly, information which can be used to adjust the grinding degree of the coffee grinder 18 to guarantee that the resulting coffee meets the user's preferences.

In another embodiment, the machine 12 can include, or be associated with, a plurality of coffee grinders 18 with varying grinding degrees. The AI model 30 processes the extraction data 20 generated during the delivery process and generates an output which indicates the appropriate coffee grinder to be used for the current delivery process. For example, the machine 12 can select the recommended coffee grinder automatically.

In another embodiment, the output of the AI model 30 can be displayed to the operator, for example by means of a mechanical, acoustic, graphic, color or light display, or a combination thereof. The operator can then manually adjust the coffee grinder 18 based on the output. Alternatively, the output of the AI model 30 can be automatically sent to the coffee grinder 18 in order to adjust the grinding degree.

The output indication of the AI model 30 can also be displayed as a numerical value, or a class of numerical values, or a range of numerical values. In some implementations, these numerical values, or class of numerical values or range of numerical values, can be correlated to a preferred delivery time for the preparation of a desired type of coffee-based beverage, which serves as a reference for the operator.

According to possible embodiments, which can be combined with all embodiments described here, the extraction chamber 14 consists of a fixed component 14a and a removable component 14c, also called filter holder, which can be temporarily combined with the fixed component 14a. At least one outlet duct 14b of the liquid coffee is present, to deliver the latter from the extraction chamber 14.

The removable component 14c is suitable to contain a desired quantity of powdered coffee 16 in the selected granulometry.

According to possible solutions, the removable component 14c has a geometry and sizes suitable to define the volume of the extraction chamber 14, once the removable component 14c is temporarily combined with the fixed component 14a.

The removable component 14c can therefore define a containing compartment into which powdered coffee in the selected granulometry can be inserted. The containing compartment is placed in fluidic communication with the outlet duct 14b.

The water necessary to prepare the coffee, for example fed by a pump 42 as described below using FIG. 3, is fed into the containing compartment, passes through the powdered coffee 16 contained therein and exits through the outlet duct 14b.

According to possible embodiments, the outlet duct 14b can be integral with the removable component 14c, or fixed.

Once the removable component 14c is coupled to the fixed component 14a, the extraction chamber 14 has a fixed volume.

In some embodiments, described using FIGS. 2 and 3, and which can be combined with all embodiments described here, the machine 12 comprises a sensor 49 for measuring or detecting the pressure in the extraction chamber 14. In some embodiments, the AI model 30 can process the pressure values generated by the sensor 49 as input, and generates an output data set which indicates the appropriate grinding degree for the coffee grinder 18.

In other embodiments, which can be combined with all embodiments described here, the machine 12 includes a sensor 47 for measuring or detecting the flow of water fed into the extraction chamber 14. In some embodiments, the AI model 30 can process the pressure values generated by the sensor 47 as input, and generates an output data set which indicates the appropriate grinding degree for the coffee grinder 18.

In other embodiments, which can be combined with all embodiments described here, the machine 12 comprises a sensor 48 for measuring or detecting the temperature of the heated water introduced into the extraction chamber 14. In some embodiments, the AI model 30 can process the temperature values generated by the sensor 48 as input, and generates an output data set which indicates the appropriate grinding degree for the coffee grinder 18.

In other embodiments, which can be combined with all embodiments described here, the machine 12 can include a sensor for measuring or detecting the moisture in the extraction chamber 14. The AI model 30 processes the moisture values generated by the sensor as input, and generates an output data set which indicates the appropriate grinding degree for the coffee grinder 18.

In some embodiments, which can be combined with all embodiments described here, the machine 12 can include a combination of two or more of the aforementioned sensors, for example a pressure sensor 49 and a flow measurement sensor 47, a pressure sensor 49 and a temperature measurement sensor 48, a flow measurement sensor 47 and a temperature measurement sensor 48, or all three of these sensors 47, 48, 49, or one, two or more of the sensors 47, 48, 49 also combined with a moisture sensor, or all four of these sensors.

In some embodiments, which can be combined with all embodiments described here, the machine 12 is capable of preparing a coffee-based beverage following one or more characteristic curves of coffee extraction, characterized by typical extraction process parameters, for example pressure in the extraction chamber 14, flow of the water fed into the extraction chamber 14 and/or temperature of the water fed into the extraction chamber 14.

These characteristic curves can be present in a storage device 25 associated, locally or remotely (for example via cloud computing architecture), with the machine 12 and be recalled by a control unit 22, also local or remote, as indicated above, associated with the machine 12, in order to operate extraction components of the machine, such as pump, heater, delivery valve and/or others for example, and perform a desired extraction and produce a quantity of coffee-based beverage.

The extraction characteristic curves can identify the nominal operating parameters of the machine 12 to obtain a liquid coffee with the desired properties.

The extraction characteristic curves can therefore identify the trend over time of at least pressure, temperature and flow of water that is introduced into the extraction chamber 14, for each instant of the delivery time, or interval, of the liquid coffee.

The control unit 22 can be, or include, or be locally or remotely associated with a computer system which can comprise a central processing unit, or CPU, an electronic memory (which can be the storage device 25 or other memory), an electronic database and auxiliary (or I/O) circuits (not shown).

For example, the CPU can be any form of computer processor which can be used in computing for processing by means of artificial intelligence algorithms. The memory can be connected to the CPU, and be one or several of any commercially available memories, such as a random access memory (RAM), a read-only memory (ROM), a floppy disk, a hard disk, mass memory, or any other form of digital storage whatsoever, local or remote. The software instructions and data can for example be encoded and stored in the memory to command the CPU. The auxiliary circuits can also be connected to the CPU in order to assist the processor in a conventional manner. The auxiliary circuits can include, for example, at least one of either: cache circuits, power circuits, clock circuits, input/output circuitry, subsystems and suchlike. A program (or computer instructions) readable by the computer system can determine which tasks are achievable in accordance with the method according to the present disclosure. In some embodiments, the program is a software readable by the computer system. The computer system includes a code for generating and storing information and data, introduced or generated in the course of the method in accordance with the present disclosure.

Some embodiments can provide to execute various steps, passages, and operations in accordance with the embodiments described here. These steps, passages and operations can be performed with instructions executed by a machine which cause the execution of certain steps by a general-purpose or special-purpose processor. Alternatively, these steps, passages and operations can be executed by specific hardware components that contain hardware logic to perform the steps, or by any combination of programmed computer components and custom hardware components.

Some embodiments of the method in accordance with the present disclosure can be included in a computer program storable in a computer-readable medium that contains the instructions which, once executed by the apparatus described here, result in the execution of the method in question.

In particular, some elements according to the present invention can be supplied as machine-readable means for storing machine-executable instructions. The machine-readable means can include, but are not limited to, floppy disks, optical disks, CD-ROMs and magneto-optical disks, ROMS, RAMs, EPROMs, EEPROMs, optical or magnetic cards, wired and/or wireless propagation means or other types of machine-readable media suitable to store electronic information. For example, some embodiments described here can be downloaded as a computer program that can be transferred from a remote computer (for example, a server) to a requesting computer (for example, client), by means of data signals created with wave carriers or other propagation means, via a communication link (for example, a wired and/or wireless modem or network connection).

In some embodiments, the machine 12 can, for example, be a machine as described in International Application WO-A-2019/102509, incorporated here in its entirety as reference.

For example, in some embodiments, which can be combined with all embodiments described here, the machine 12 (FIG. 3) can comprise a circuit 40 provided with at least one pump 42, connected to a water supply source 41 and configured to feed a controlled quantity of pressurized water, a heating device 43 configured to heat the water supplied by the pump 12, an extraction chamber 14 located downstream of the heating device 43 and configured to contain a desired quantity of powdered coffee 16, and a selectively adjustable delivery valve 44 for controlling the delivery flow of the liquid coffee at exit from the extraction chamber 14. The delivery valve 44 can, for example, be of the proportional type.

In some embodiments, which can be combined with all embodiments described here, the machine 12 can include sensors 45, 46, 47, 48, 49 configured to detect at least one operating parameter of the circuit 40, a user interface 23, connected to the control unit 22, with which a user can select one of a plurality of liquid coffee recipes, and a storage device 25 for storing a list of characteristic curves of liquid coffee extraction, each curve being associated with one of the recipes. The sensors 45, 46, 47, 48, 49 are configured to detect, repeatedly during the delivery time, the at least one operating parameter of the circuit 40.

In some embodiments, which can be combined with all embodiments described here, the sensors 45, 46, 47, 48, 49 generally comprise one or two temperature sensors 46, 48, for example a first 46 upstream and/or a second 48 downstream of the heating device 43, one or two pressure sensors 45, 49, for example a first 45 of which is located between the pump 42 and the heating device 43 and/or a second 49 of which is located in the extraction chamber 14, and a flow sensor 47, or flow meter, located downstream of pump 42. The sensors 45, 46, 47, 48, 49 are configured to detect, repeatedly during the delivery time, respective ones of the operating parameters of the circuit 40, comprising pressure and flow rate downstream of the pump 42, temperature upstream and downstream of the heating device 43, and pressure inside the extraction chamber 12. Possibly, a moisture sensor can also be provided.

By way of example only, the recipes according to which various types of coffee can be prepared with the machine 12 can be related to the type of liquid coffee delivered, for example espresso, long, American or cold coffee, and/or related to the type or origin of coffee to be used.

One of the above mentioned characteristic curves of liquid coffee extraction can be associated with each recipe.

Following its characteristic curves, the machine 12 can therefore prepare a coffee-based beverage. During the extraction process, an automated sequence of inputs 19 is generated, which prescribes the setpoints for various physical quantities, such as temperature, pressure and flow, which the machine 12 will follow during the delivery process.

For example, the pressure setpoints generate a curve for the pressure in the extraction chamber 14 (similarly for temperature and flow), which, in some embodiments, can then be used as input for the algorithm of the AI model 30 to determine the appropriate grinding degree for the coffee grinder 18.

In some embodiments, which can be combined with all embodiments described here, the operating mode of the machine 12 includes delivering a coffee and detecting the development of at least one process parameter over time, for example pressure. The machine 12 receives an automated sequence of temporally serialized inputs 19, as a consequence of which the extraction of the coffee is carried out and the values of the corresponding parameters of the extraction process, for example pressure, are sampled over time and supplied as sets of extraction data 20, for example pressure, to the AI model 30, in order to determine the appropriate grinding degree for the coffee grinder 18. During the execution of the extraction process, as a consequence of the automated sequence of inputs 19 received, the desired one or more process parameters, for example the pressure in the extraction chamber 14, are continuously sampled and generate a set of extraction data 20 supplied as input to the AI model 30. The latter processes the data received and generates an output data set which contains information corresponding to an indication of the appropriate grinding degree for the coffee grinder 18. The output of the AI model 30 can therefore be used to automatically adjust the coffee grinder 18, or shown to the operator for manual adjustment.

In another embodiment, the operation of calibrating the coffee grinder 18 can include adjusting the distance between the grinders of the coffee grinder 18, which changes the setting (often referred to as “notch”) of the coffee grinder 18 itself, as for example described below using FIG. 6. In other embodiments, which can possibly be combined with the adjustment of the distance between the grinders, the calibration of the coffee grinder 18 can include adjusting the duration of an activation time of the grinders of the coffee grinder 18.

The output of the AI model 30 gives an indication of the extent of this adjustment, which for example can be manual, indicating how many notches the setting should be moved by, or automatic. In particular, the adjustment of the coffee grinder 18 can be performed manually by the operator based on the output of the AI model 30, or it can be performed automatically by the machine 12 using the control unit 22 which sends an appropriate signal to the coffee grinder 18. This allows for a precise and accurate calibration of the coffee grinder 18 to achieve the optimal grinding degree for the powdered coffee.

The AI model 30 can be trained by means of training data sets obtained in one or more data acquisition campaigns in which a plurality (for example hundreds) of coffee extraction processes are carried out, for various grinding degrees, or granulometry, of the coffee and also for various coffee roasts. Each extraction is coupled to the desired output, therefore according to a supervised learning approach. In general, any regression model could be used with a correct definition of the input data.

The Applicant has experimented with various architectures for the machine-learning based AI model 30 which can be used in the embodiments described here.

The algorithm, therefore, can be a machine-learning based algorithm, in particular a model-based machine-learning algorithm, more in particular a supervised learning algorithm (supervised machine-learning).

In particular, the machine-learning algorithm can be or include, for example, a neural network or combination of neural networks, linear regression, deep learning or decision trees, or any other that falls within the definitions provided above.

For example, a neural network model takes as input the set of extraction data 20 generated from the entire automated sequence of inputs 19, while simple models (linear regression, decision trees, random forest, gradient boosted trees, bagging regressors, support vector regressor, etc.) take as input a set of statistical quantities calculated from the set of extraction data 20 generated from the entire automated sequence of inputs 19 (for example mean, standard deviation, skewness, . . . ).

In some embodiments, the AI model 30 can be based on a neural network.

In this case, the data generated by the machine 12 are a multivariate time series sampled at a desired frequency, for example between 2 Hz and 10 Hz, for example 3 Hz, 4 Hz, 5 Hz, 6 Hz. Instead, the data used for the neural network training consists of a multivariate or univariate time series (values of a process parameter recorded during the coffee extraction process).

In some embodiments, the AI model 30 can be based on a convolutional neural network (CNN) and/or a recurrent neural network (RNN).

According to some embodiments, the CNN and RNN networks have the same input extraction data 20 and the same type of output 21 (naturally, the numerical value of the output could be different, since it derives from two different models). The CNN and RNN networks can therefore be used individually, interchangeably and, with the view of combining them in an ensemble model, as better explained below, they can work in parallel.

The CNN is used to extract features from the data, while the RNN is used to capture time dependencies between data points. The combination of these two neural network architectures allows for an accurate prediction of the appropriate grinding degree.

In some embodiments, it is possible to use an ensemble of neural networks. An ensemble of neural networks is a set of multiple neural networks that work together to achieve a better performance than that achieved by a single network. There are several ways networks can be combined, such as averaging their predictions or selecting the prediction of a specific network based on its performance. Using an ensemble of neural networks can help reduce overfitting and improve the robustness of the model.

In particular, the AI model 30 can be an ensemble model, which combines the predictions of the CNN model and one or more recurrent neural network (RNN) models. There are several ways to create an ensemble of convolutional neural networks (CNNs) and recurrent neural networks (RNNs), some of which are stacking, bagging, boosting, combining.

As indicated above, in possible implementations, in the ensemble model the CNN and RNN networks can be combined to work in parallel.

For example, in possible implementations which can be used in the present invention, the ensemble model can use the average of the predictions of the individual models to generate the final output. This approach can give greater accuracy and robustness in the prediction of the appropriate grinding degree for the coffee grinder 18.

In another embodiment, the CNN architecture can be a model inspired by WaveNet (CNN WaveNet Inspired). WaveNet is a specific neural network architecture used for text and audio generation, introduced by Google DeepMind in 2016. Its architecture is based on a series of convolutional dilation layers, where each layer dilates the convolution window to capture long-distance relationships between input data. A CNN WaveNet Inspired neural network combines the WaveNet architecture with the CNN, with the objective of using the WaveNet architecture to capture long-distance relationships between input data, and the CNN to process the input data. In particular, the CNN WaveNet Inspired neural network which can be used in the embodiments described here can be a network with a structure similar to that of WaveNet (convolutional layers with increasing dilation rates), but with a reduced number of levels and parameters, and modified for the regression activity to which it is applied.

The combination of CNN WaveNet Inspired and RNN can be achieved, for example, by making CNN WaveNet Inspired and RNN work in parallel, as indicated above.

Moreover, according to some embodiments, it is possible to use CNN WaveNet Inspired as a processing layer followed by an RNN: in this method, a CNN WaveNet Inspired is trained to process the input data, the output is used as input for an RNN, then the RNN is used to analyze the temporal relationships between the processed data.

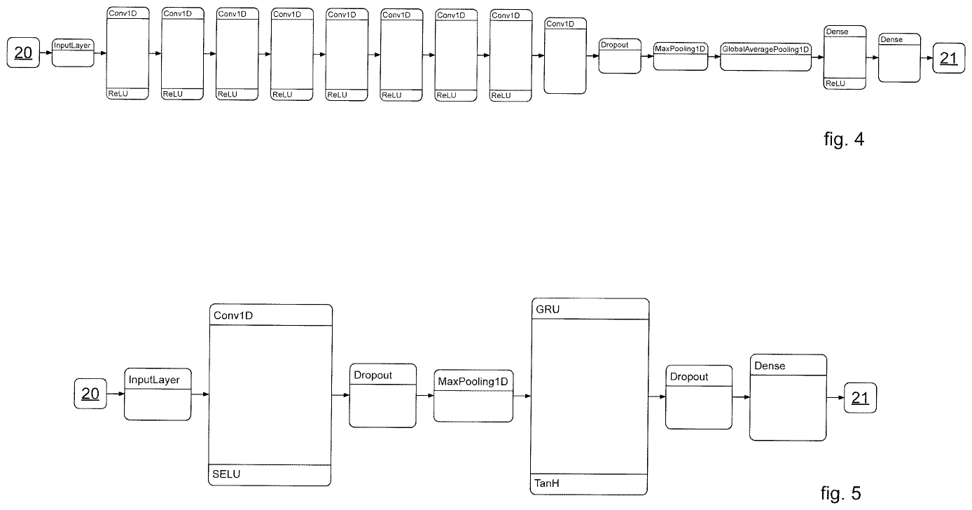

FIG. 4 is used to describe some embodiments of a CNN WaveNet Inspired network as usable in the embodiments described here. It receives the set of extraction data 20 as input. In some embodiments, the CNN includes: input layer, a plurality of convolution layers 1D (temporal convolution, Conv1D), each with a respective activation function (for example Relu, rectified linear unit or rectifier) with the exception of the last, a dropout layer, a plurality of pooling layers (for example MaxPooling 1D layer and GlobalAveragePooling 1D layer), a plurality of dense layers, with respective activation function (for example Relu, rectified linear unit or rectifier) with the exception of the last one that supplies the output of the CNN network. Conv1D layers preferably comprise a first group of layers, each having a dilation rate greater than the previous one (for example, doubling) and a second group of layers with dilation rates like those of the first group, that is, increasing. For example, a first group of Conv1D layers can have dilation rates of 1, 2, 4, and 8, and so on, respectively, while the second group of Conv1D layers can also have dilation rates of 1, 2, 4, and 8, and so on. A specific example provides: one input layer, eight Conv1D layers, one dropout layer, one MaxPooling 1D layer and one GlobalAveragePooling1D layer, two dense layers.

FIG. 5 is used to describe some embodiments of a RNN network as usable in the embodiments described here. In some embodiments, the RNN includes: input layer, one or more convolution layers 1D (temporal convolution, Conv1D), with respective activation function (for example Selu, scaled exponential linear unit), a dropout layer, one or more pooling layers (for example MaxPooling 1D layer), one or more recurring layers (for example Gated Recurrent Unit, Gru), with respective activation function (for example TanH, hyperbolic tangent), another dropout layer, and one or more dense layers. A specific example provides: one input layer, one Conv1D layer, one dropout layer, one MaxPooling 1D layer, another dropout layer and one dense layer.

Consequently, according to some embodiments, the AI model 30, in particular for use in the calibration method described here, can be based on neural networks, in particular CNN and/or RNN or CNN combined with RNN, more in particular an ensemble model of CNN and RNN. For example, the CNN can be WaveNet Inspired. The CNN and RNN networks can be in accordance with the embodiments described using FIGS. 4 and 5, respectively.

In other embodiments, the AI model 30 can be based on linear regression.

Linear regression is a supervised learning technique used to establish a linear relationship between one or more independent variables (also called features or inputs) and one dependent variable (also called target or output). The linear relationship is given by a mathematical function which, for example, has the form y=a+b*x where y is the dependent variable, x is the independent variable, a and b are the parameters or coefficients of the model. Linear regression tries to find the optimal values for the parameters a and b that best describe the linear relationship between x and y. The model thus obtained can be used to predict the value of y given a known value of x. Naturally, the number of independent variables can be greater than 1. In general, it is possible to indicate the predicted value as given by the relationship y=w₀+w₁*x₁+w₂*x₂ . . . wₚ*xₚ, where p is the number of features and w₀, w₁, w₂ . . . wₚ are the coefficients.

In this case, there is provided a step of pre-processing the data and a step of extracting the data, which is then supplied to the linear regression model. The set of extraction data 20 generated from the automated sequence of inputs 19 can be processed to extract useful features, which will be used as inputs in a regression model. Some examples of these features are-but not limited to-the mean value, the standard deviation and the maximum value of both the process parameter used (for example pressure or flow or temperature as defined here) during the extraction and the first discrete difference of the process parameter used. In this case, it is important to extract useful features, that is, features that show a correlation with the target variable.

Once the features have been chosen, the linear regression model can be constructed by adapting a linear model with coefficients as indicated above, in order to minimize the residual sum of the squares between the targets observed in the data set and the targets predicted by the linear approximation.

In some embodiments, which can be combined with all embodiments described here, the AI model 30 can comprise a common structure generally consisting of:
data preprocessing, to extract the statistical features;
data standardization, for example with the StandardScaler function;
introduction of polynomial features, by means of which the original features are transformed into polynomial features of a certain degree to then apply the linear regression;
regularization for linear regression models, for example ridge regression model (statistical regularization technique to correct overfitting in machine-learning models).

The algorithm of the AI model 30 generally takes into consideration three process variables: the pressure generated in the extraction chamber, the flow of water entering the extraction chamber, the temperature of the aforementioned water. As described above, it is possible for two of these process variables to be fixed at the setpoint value and detected, and a third of choice is left free to vary and detected.

In one example embodiment, the water flow and the temperature follow predetermined setpoints thanks to the control systems; the pressure is instead left free to vary, so as to observe the hydraulic response of the coffee brick in the extraction chamber 14.

In other example embodiments, it can be provided to observe, for example, the variation in flow, subjecting the coffee brick to a constant hydraulic head.

During the steps of data acquisition, data analysis and system development, the Applicant has found that the grinding control process, object of the embodiments described here, which in general terms can include the grinding of the coffee, preparation of the dose, extraction in the machine to prepare the coffee beverage, is a process subject to strong uncertainty and which generates noise, due for example to:
a) intrinsic factors of the process:
   the granulometry of a dose of coffee follows a certain probability distribution; for example, in the case of two doses prepared with the same grinder, the same setting, the same coffee, they could have a different distribution, and the macroscopic behavior manifested by the two preparations differs;
   the individual coffee beans that are ground could originally exhibit a slightly different roasting, which leads to variability and uncertainty in the process;
   preparation of the dose itself.
b) environmental conditions that cannot be kept under control:
   ambient moisture;
   head of the grains of coffee that insists on the grinders of the coffee grinder.

Regarding the strong uncertainty and generation of noise, in the step of training and selecting the model, the Applicant has found that neural network models, although more precise on the training data, may be less accurate in the testing step, due to overfitting, a situation in which a model adapts so much to the training data that it is not able to generalize and make correct predictions for new data.

Hence, the Applicant has found that by using a simpler model, in particular regularized linear regression, for example with ridge regression, possibly combined with a more in-depth step of selecting and extracting the features, it is possible to obtain better results in terms of robustness against overfitting; the model with fewer parameters manages to generalize the problem better, managing to mitigate the noise of the process and thus obtaining only useful information from the learning data.

Hence, the Applicant has found that the choice to use linear regression as a machine-learning algorithm, in particular regularized, for example with ridge regression, can also be advantageous in relation to the problems of uncertainty and noise of the system as above.

In general, with reference to the algorithms of the AI model 30, the Applicant has adapted the generic structure indicated above for each roast (classic, intense, strong, decaffeinated) in order to achieve a better result. In particular:
classic coffee:
   statistical features: the maximum value, average value and the standard deviation of the pressure, the pressure reached at a specific volume are considered;
   standard scaler;
   second-degree polynomial features;
   ridge regression with regularization coefficient alpha equal to 0.1;
intense coffee:
   statistical features: the maximum value, average value, the standard deviation of the pressure are considered;
   standard scaler;
   second-degree polynomial features;
   ridge regression with regularization coefficient alpha equal to 1;
strong coffee:
   statistical features: the maximum value, average value and the standard deviation of the pressure, the pressure reached at a specific volume are considered;
   standard scaler;
   first-degree polynomial features;
   ridge regression with regularization coefficient alpha equal to 0.1;
decaffeinated coffee:
   statistical features: the maximum value, average value, the standard deviation of the pressure and of its second derivative are considered;
   standard scaler;
   first-degree polynomial features;
   ridge regression with regularization coefficient alpha equal to 1.

The Applicant believes that the architecture provided will, in the future, also allow to create models for different target grinds, for example mocha and filter, for each of the mixtures and roasts described here.

FIG. 6 is used to describe some embodiments, which can be combined with all embodiments described here, of a coffee grinder 18, in which the distance of the grinders is adjustable in order to calibrate the grinding degree on the basis of the indications obtained according to the present invention. As a non-limiting example, such a coffee grinder can be manufactured as described in International Application WO-A-2016/166216 in the name of the Applicant and incorporated here in its entirety as reference.

In some embodiments, the coffee grinder 18 includes a grinding member 50 configured to grind coffee beans and produce powdered coffee 16, a transit chamber 51 configured to receive the powdered coffee 16 ground by the grinding member 50, and a discharge member 52 configured to discharge the powdered coffee 16 coming from the transit chamber 51. There is also an inlet aperture 53 through which to feed the coffee beans, coming from a feeding member 71, and an outlet aperture 54 through which the powdered coffee 16 is discharged to the outside.

In some embodiments, which can be combined with all embodiments described here, the grinding member 50 includes two reciprocally mobile grinders 55, 56, and is configured to perform the grinding by exploiting a relative rotational movement of the aforementioned grinders. This rotational movement generates a centrifugal force acting on the powdered coffee 16, which directs it toward the transit chamber 51, and from there toward the discharge member 52.

Generally, the grinders 55, 56 are coaxial with respect to a common central axis Z. The grinders 55, 56 are typically provided with grinding teeth provided on respective grinding surfaces.

Moreover, the grinders 55, 56 are able to move relative to each other, at least for the purposes of carrying out the grinding operation. In particular, a grinder 55, or rotor, that is mobile during grinding and a fixed grinder 56, or stator, that is stationary during grinding can be provided. The terms “mobile/rotor” and “fixed/stator” refer to the respective condition of the grinders 55, 56 during the grinding operation.

The reciprocal movement of the grinders 55, 56 for the purposes of the grinding can be determined by an actuation unit 57. In accordance with some embodiments, the actuation unit 57 can include a motor 58 provided with a drive shaft 59 and configured to determine the desired reciprocal movement of the grinders 55, 56. A base body 60 can be provided which sustains the actuation unit 57, in particular the motor 58.

In some embodiments, the grinders 55, 56 are configured mobile in reciprocal rotation, around a common central axis Z. In particular, the grinder 55 can be made to rotate around the cited central axis Z, while the fixed grinder 56 remains stationary. To this end, the grinder 55 can be connected to the rotation shaft 59, driven by the motor 32.

In possible implementations, the grinders 55, 56 are configured male-female. Since they are mating in shape, the grinders 55, 56 are inserted into each other. The grinders 55, 56 have, for example, essentially a mating truncated-conical shape. In this configuration, the truncated-conical grinders have grinding surfaces inclined by a certain angle of inclination. For example, the angle of inclination can be comprised between 12° and 22°, in particular between 15° and 20°, more in particular between 16° and 18°.

In implementations in which the grinders 55, 56 are one inside the other, coaxial, and reciprocally mobile in rotation around the central axis Z for the purposes of the grinding, it can be provided that the grinder 55 is internal, that is, it is disposed inside the grinder 56, which therefore completely surrounds it on the outside.

The grinding operation actuated by means of the grinding member 50 can typically be influenced by different construction and operating parameters. The construction parameters are generally fixed and decided by the grinders' manufacturer, such as the geometry of the grinding body and teeth, friction and surface hardness of the grinders linked to the materials and works used. The operating parameters can be variable as a function of the ingredients used, the atmospheric conditions and the result desired in the cup, such as for example the distance between the grinders 55, 56, and/or the rotation speed of the grinders 55, 56 and/or the activation time of the grinding member 50.

In possible embodiments, described using FIG. 6 and which can be combined with all embodiments described here, the relative distance between the grinders 55, 56 can be adjustable, in order to vary the granulometry of the ground powdered coffee 16. Advantageously, the order of magnitude of the adjustability of such distance is micrometers. The adjustability can be manual, or made automatic or semi-automatic. Consequently, the grinders 55, 56 are able to move relative to each other, toward/away from each other along the central axis Z, also in order to carry out the operation of adjusting their reciprocal distance.

For example, for the purposes of the adjustment, the grinder 56 can be made to move axially away from/toward the grinder 55. The possibility that the grinder 56 is mobile with respect to the grinder 55 for the purposes of adjusting the reciprocal distance should not be understood here as in contrast to the fact that the grinder 56 remains stationary and the grinder 55 is made to move during the grinding operation. Moreover, the operation of adjusting the distance between the grinders 55, 56 is carried out before the grinding operation, and during this operation the distance, once it has been preliminarily set, is not varied.

In particular, the adjustment can be carried out by making the grinder 56 rotate around the central axis Z, while the grinder 55 is kept stationary.

In possible implementations, with each complete revolution the grinder 56 descends by a certain descent length and then moves away from the grinder 55 by a length correlated to the trigonometric function of the sine of the angle of inclination and of the aforementioned descent length. With each degree of rotation, depending on the sense of rotation, the grinder 56 moves away from/toward the grinder 55 by a distance in the order of micrometers, in particular between 0.5 microns and 2 microns, more in particular between 0.75 microns and 1.5 microns, for example 1 micron. It is possible to control this approaching/distancing movement between the grinder 55 and the grinder 56 by means of a micrometric control system. Therefore, the grinder 55 and the grinder 56 can be disposed at a variable distance from each other to selectively define a grinding gap, or pitch, correlated to a desired granulometry of the ground powdered coffee 16 to be obtained.

In possible embodiments, described using FIG. 6 and which can be combined with all embodiments described here, the coffee grinder 18 can include an automatic adjustment unit 61 configured to adjust the reciprocal distance between the grinders 55, 56.

In some embodiments, which can be combined with all embodiments described here, the automatic adjustment unit 61 can include an adjustment body 62 associated with the grinder 56. The adjustment body 62 is mobile, so as to allow the positioning of the grinder 56 with respect to the grinder 55 for the purposes of the adjustment.

In some embodiments, which can be combined with all embodiments described here, the adjustment body 62 is axially associated along the central axis Z with a support body 63 by means of a threaded coupling 64. For example, the adjustment body 62 is inserted, in particular, inside the support body 63. Since the adjustment body 62 can be screwed to the support body 63, it is mobile with respect to the support body 63, in rotation around the central axis Z and axially along the same central axis Z. In addition, the adjustment body 62 is integrally connected to the grinder 56, for example by means of one or more screws 65. In this way, the adjustment body 62 drags the grinder 56 in motion with it, determining its advance/retraction along the central axis Z. Thanks to the threaded coupling 64, by rotating the adjustment body 62, an axial displacement is also determined, advancing or retracting, depending on the sense of rotation, of the adjustment body 62 itself, and therefore of the grinder 56. This displacement along the central axis Z allows, therefore, to modify the width of the gap between the grinders 55, 56.

In some embodiments, which can be combined with all embodiments described here, the automatic adjustment unit 61 can also include a driven pulley 66 keyed to the adjustment body 62. There is provided a motion transmission member 67 wrapped around the driven pulley 66. A drive pulley 68 is also provided. The motion transmission member 67 is wound around the drive pulley 68. The drive pulley 68 is connected to an actuation element 69 configured to actuate the rotational movement of the drive pulley 68, clockwise or counterclockwise, as needed. Advantageously, the automatic adjustment unit 61 is configured in such a way that each degree of rotation of the driven pulley 66, and therefore of the adjustment body 62, corresponds to a micrometric adjustment movement, in particular between 0.5 micron and 2 micron, more in particular between 0.75 micron and 1.5 micron, for example of approximately 1 micron, of the grinder 56 with respect to the grinder 55. Advantageously, an angular position transducer, or encoder, 70 can be provided associated with the actuation element 69, by means of which to precisely command and control the angular rotation given to the drive pulley 68 and, therefore, reliably and precisely control the adjustment of the grinding granulometry. In particular, thanks to the angular position transducer, or encoder, 70 it is possible to precisely control the degrees of rotation of the grinder 56 and therefore its movement away from/toward the grinder 55, as described above.

In conclusion, the embodiments described here provide a method and apparatus for automatically supplying reliable information for calibrating a coffee grinder 18 using an algorithm that implements an AI model 30 based on machine-learning.

The AI model 30 takes as input a plurality of extraction data 20 (for example pressure, or flow or temperatures) automatically generated by the machine 12, when a certain quantity of powdered coffee 16 is processed to prepare the coffee. In particular, the machine 12 receives an automated sequence of temporally serialized inputs 19 on the basis of which it carries out the coffee extraction process, generating extraction data 20 that are processed by the AI model 30. The output of the AI model 30 is information, which can be an indication or even a signal, on the basis of which an automatic or manual adjustment is made on a coffee grinder, which can for example be integrated in the machine or external, or on the basis of which information a specific coffee grinder is chosen from a variety of grinders available, with different grinding degrees.

The embodiments described here enable an accurate prediction of the appropriate grinding degree, and eliminate the need for manual intervention and the need for specific skills of the operator.

In some embodiments, integrating the coffee grinder 18 and the machine 12 into a single coffee preparation machine can further simplify the process and supply a convenient solution for operators. It is not excluded, however, that the embodiments described here also apply in the event that the coffee grinder 18 and machine 12 are not integrated into a single machine.

Moreover, connectivity to a network allows the remote monitoring and control of the machine 12, and the user interface allows the operator to enter various preferences and parameters. The presence of one or several sensors for the measurement of various physical quantities in the extraction chamber 14 allows a further optimization of the extraction process and of the resulting coffee.

It is clear that modifications and/or additions of steps and/or parts may be made to the machine 12 for preparing coffee, to the method and apparatus 10 as described heretofore, without departing from the field and scope of the present invention, as defined by the claims.

It is also clear that, although the present invention has been described with reference to some specific examples, a person of skill in the art will be able to achieve other equivalent forms of machine for preparing coffee, method and apparatus, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A machine for preparing coffee, the machine comprising:
at least one coffee grinder comprising a plurality of grinders configured to grind coffee beans into powdered coffee;
a coffee extraction chamber configured to receive and hold the powdered coffee from the at least one coffee grinder;
a controller configured to receive extraction data one or more process parameters acquired over time during at least one coffee extraction operation carried out in the coffee extraction chamber; and
at least one processor configured to process the extraction data using an algorithm that implements an artificial intelligence model based on machine-learning, the algorithm generating output data including information used to calibrate the at least one of coffee grinder at least by adjusting a distance between two of the plurality of grinders,
wherein the one or more process parameters include at least one of pressure measured in the coffee extraction chamber, flow rate of water fed into the coffee extraction chamber, or temperature of water fed into the coffee extraction chamber.

2. (canceled)

3. The machine of claim 1, wherein the algorithm is based on a neural network selected from the group consisting of a convolutional neural network (CNN), a recurrent neural network (RNN), and a combination thereof.

4. The machine of claim 1, wherein the artificial intelligence model is based on linear regression or on ridge regression regularized linear regression.

5. (canceled)

6. The machine of claim 1, wherein:
the process parameters include the pressure measured in the coffee extraction chamber, the flow rate of water fed into the coffee extraction chamber, and the temperature of water fed into the coffee extraction chamber, and
two of the process parameters are fixed at a desired setpoint value, and a third of the process parameters is variable.

7. The machine of claim 1, wherein the machine is configured to perform a coffee extraction operation based on an automated sequence of temporally serialized process parameters supplied as extraction data to the artificial intelligence model to determine an appropriate grinding degree used to adjust the distance between two of the plurality of grinders.

8. The machine of claim 1, wherein:
the coffee extraction chamber comprises a fixed component. a removable component removably connected to the fixed component, and at least one outlet duct to deliver the-liquid coffee from the coffee extraction chamber,
the removable component defines a containing compartment for holding the powdered coffee,
the containing compartment is in fluid communication with the outlet duct,
the machine further comprises a pump configured to introduce water into the containing compartment,
the machine further comprises a sensor configured to measure the pressure in the coffee extraction chamber, and
the at least one processor is configured to process at least the pressure measured by the sensor to generate the output data.

9. The machine of claim 1, further comprising a sensor configured to measure the flow rate or the temperature of water fed into the coffee extraction chamber,
wherein the at least one processor is configured to process flow rates or temperatures measured by the sensor to generate the output data.

10. (canceled)

11. The machine of claim 1, wherein:
the machine is configured to prepare a coffee-based beverage based on one or more characteristic curves of coffee extraction based on the one or more process parameters,
the characteristic curves are stored in a storage device that is local to the machine or remote from the machine, and
the controller recalls the characteristic curves from the storage device to produce a quantity of the coffee-based beverage.

12. The machine of claim 1, further comprising:
a water supply source:
a pump in fluid communication with the water supply source, the pump being and configured to feed a controlled quantity of pressurized water;
a heating device configured to heat the water supplied by the pump, wherein the coffee extraction chamber is disposed downstream of the heating device;
a delivery valve configured to control the delivery flow of the liquid coffee from the coffee extraction chamber;
one or more sensors configured to measure the one or more process parameters repeatedly during delivery of the coffee;
a user interface configured to receive a selection one of a plurality of liquid coffee recipes; and
a storage device configured to store a list of characteristic curves of liquid coffee extraction, each of the characteristic curves being associated with one of the liquid coffee recipes.

13. The machine of claim 12, wherein the one or more sensors comprise at least one of:
a first temperature sensor upstream of the heating device,
a second temperature sensor downstream of the heating device,
a first pressure sensor is disposed between the pump and the heating device,
a second pressure sensor disposed in the coffee extraction chamber, or
a flow sensor disposed downstream of the pump.

14. The machine of claim 1, wherein calibrating the coffee grinder is further by adjusting a duration of an activation time of the plurality of grinders based on the output data generated by the artificial intelligence model.

15. A method for preparing coffee in a machine including at least one coffee grinding comprising a plurality of grinders configured to grind coffee beans into powdered coffee and a coffee extraction chamber configured to receive and hold the powdered coffee, the method comprising:
receiving extraction data including one or more process parameters acquired over time during at least one coffee extraction operation carried out in the coffee extraction chamber; and
processing the extraction data using at least one processor using an algorithm that implements an artificial intelligence model based on machine-learning, the algorithm generating output data including information used to calibrate the coffee grinder at least by adjusting a distance between two of the plurality of grinders,
wherein the one or more process parameters include at least one of pressure measured in the coffee extraction chamber, flow rate of water fed into the coffee extraction chamber, or temperature of water fed into the coffee extraction chamber.

16. (canceled)

17. The method of claim 15, wherein the algorithm is based on a neural network selected from the group consisting of a convolutional neural network (CNN), a recurrent neural network (RNN), and a combination thereof.

18. The method of claim 15, wherein the artificial intelligence model is based on linear regression or on ridge regression regularized linear regression.

19. (canceled)

20. The method of claim 15, wherein:
the process parameters include the pressure measured in the coffee extraction chamber, the flow of water fed into the coffee extraction chamber, and the temperature of water fed into the coffee extraction chamber, and
two of the process parameters are fixed at a desired setpoint value, and a third of the process parameters is variable.

21. (canceled)

22. The method of claim 15, further comprising:
measuring the pressure in the coffee extraction chamber, the flow rate of water fed into the coffee extraction chamber, or the temperature of water introduced into the coffee extraction chamber using a sensor; and
processing at least the pressures, the flow rates, or the temperatures measured by the sensor to generate the output data.

23-24. (canceled)

25. The method of claim 15, further comprising:
preparing a coffee-based beverage based on one or more characteristic curves of coffee extraction based on the one or more process parameters, wherein the characteristic curves are stored in a storage device that is local to the machine or remote from the machine, and
recalling the characteristic curves from the storage device to produce a quantity of coffee-based beverage.

26. The method of claim 15, further comprising:
feeding a controlled quantity of pressurized water from a water supply source using a pump;
heating water from the water supply source using a heating device;
selectively controlling the delivery flow of the liquid coffee from the coffee extraction chamber;
measuring the one or more process parameters using one or more sensors; and
receiving a selection of one of a plurality of liquid coffee recipes via a user interface, each of the plurality of liquid coffee recipes being associated with a characteristic curve of liquid coffee extraction.

27. The method of claim 26, wherein the one or more sensors comprise at least one of:
a first temperature sensor upstream of the heating device,
a second temperature sensor downstream of the heating device,
a first pressure sensor is disposed between the pump and the heating device,
a second pressure sensor is disposed in the coffee extraction chamber, or
a flow sensor disposed downstream of the pump.

28. The method of claim 15, further comprising:
adjusting the distance between two of the plurality of grinders and adjusting the duration of an activation time of the plurality of grinders based on the output data.

29-30. (canceled)
